(19) United States
(12) Patent Application Publication
(10) Pub. No.: US 2007/0016396 A9
(43) Pub. Date: Jan. 18, 2007

(54) Apparatus and method for connecting a hardware emulator to a computer peripheral

(76) Inventor: Robert Marc Zeidman, Cupertino, CA (US)

Correspondence Address: MACPHERSON KWOK CHEN & HEID LLP, 2033 GATEWAY PLACE, SUITE 400, SAN JOSE, CA, 95110, US

(21) Appl. No.: 10/158,772

(22) Filed: May 31, 2002

Related U.S. Application Data
(63) Continuation-in-part of application No. 09/751,573, filed on Dec. 28, 2000, now Pat. No. 7,050,962.

(51) Int. Cl. G06F 9/455

(52) U.S. Cl. 703/23

(57) ABSTRACT

A system and method for connecting a hardware emulation of an electronic device to a computer peripheral that includes a computer for receiving data from the peripheral and storing the received data in a first buffer. The computer next transmits the received data to the emulation at a slower speed. The computer also receives data from the hardware emulation and stores the received data in a second buffer. The computer then transmits the data received from the hardware emulation to the peripheral.

### BACKGROUND OF THE INVENTION

Prior to reducing an integrated circuit design to a form suitable for fabrication, the integrated circuit design is often emulated to allow the design to be optimized and debugged. A hardware emulator (“emulator”) suitable for such use typically includes field programmable gate arrays (FPGAS) that serve as a breadboard for implementing the integrated circuit design. Such an emulator typically runs at a slower speed than a computer peripheral (“peripheral”) to which it is attached (e.g., a graphics card or a hard drive).

When an integrated circuit that has a peripheral interface is emulated, peripheral activities are usually emulated at the speed of the circuit emulator. A specially designed, slowed-down peripheral device is typically connected to a port of the circuit emulator. The emulator receives data from the slowed-down peripheral and transmits data to the slowed-down peripheral at the speed of the emulator. On balance, such a slowed-down peripheral requires a custom design and does not completely predict the behavior of a normal peripheral, operating at full speed, accurately and correctly. Because the peripheral is normally designed to operate at a faster speed, timing issues may arise such that it cannot be slowed down at all.

### SUMMARY OF THE INVENTION

The present invention allows a circuit emulator to connect to a computer peripheral at full operational speed using a standard interface, such as a serial port, a high-speed parallel port, a small computer system interface (SCSI) or a universal serial bus (USB).

The invention provides a method and an apparatus for transferring data between an emulated device in a circuit emulator and the computer peripheral. In one embodiment, an interface software program installed on a host computer (e.g., a personal computer) is provided to handle communication between the peripheral and the circuit emulator. The peripheral can be, for example, a graphics card or a hard drive.

According to the present invention, data from a computer peripheral on the host computer that is intended for an emulated device in the emulator is received and stored in buffers on the host computer. The interface software in the host computer repackages the data packet into a second format for transmission to the emulated device at the speed of the emulated device. Similarly, the interface software in the host computer repackages the data received from the emulator into proper format for transmission to the peripheral at full speed. Under this arrangement, the existing memory in the host computer is used to buffer data communicated between the emulator and the peripheral, so that data received from the peripheral at full speed are transmitted to the emulator at a slower speed, and data received from the emulator at the slower speed is provided to the peripheral at full peripheral speed. Thus, the costs of providing additional memory and management of such additional memory in an emulator are avoided.

In one embodiment, the interface software of the host computer is implemented as a multithreaded program having, in one instance, two executing threads. One thread is a task that receives data from the peripheral, stores the received data in a buffer, retrieves the stored data for repackaging, and sends the repackaged data over the emulator interface to the emulator. Another thread is a task that receives data from the emulator interface, repackages the data into a format for the computer peripheral, and sends the data to the computer peripheral.

In another embodiment, the interface software of the host computer is implemented as a multithread program including four executing threads. One thread is a task that receives data from the peripheral and stores the received data in a buffer. A second thread is a task that polls the buffer for the received data. This second thread repackages the data and sends the repackaged over the emulator interface to the emulator. A third thread is a task that receives data from the emulator over the emulator interface and stores the received in a second buffer. A fourth thread is a task that polls the second buffer for the data received from the emulator. This fourth thread repackages this data and sends the repackaged data to the peripheral.

In yet another embodiment, the interface software of the host computer is also implemented as a multithread program, as in the previous embodiment, except that the second buffer is eliminated and the third and fourth tasks are combined into a single task executing as a single thread. In this embodiment, the single task receives data from the emulator, repackages the data received, and sends the repackaged data to the computer peripheral. This approach is possible when the emulator runs at a much slower speed than the peripheral, such that data received from the emulator can be repackaged and sent to the peripheral before the arrival of more data from the emulator.

Further features and advantages of various embodiments of the invention are described in the detailed description below, which is given by way of example only.

### BRIEF DESCRIPTION OF THE DRAWINGS

The present invention will be understood more fully from the detailed description given below and from the accompanying drawings of the preferred embodiment of the invention, which, however, should not be taken to limit the invention to the specific embodiment but are for explanation and understanding only.

FIG. 1 shows a computer with various computer peripherals including built-in peripherals and external peripherals.

FIG. 2 shows a configuration including a workstation, a host computer running EmBridge software, and a hardware emulator, in accordance with the present invention.

FIG. 3 shows a block diagram of typical computer software including low-level hardware drivers, an operating system, an application program, and a user interface.

FIG. 4 is a block diagram showing one configuration of an emulator during an emulation of a device that interfaces with a computer peripheral.

FIG. 5 is a block diagram showing the functions performed by EmBridge program in accordance with one embodiment of the present invention.

FIG. 6 is a block diagram showing the functions performed by EmBridge program in accordance with a second embodiment of the present invention.

FIG. 7 is a block diagram showing the functions performed by EmBridge program in accordance with a third embodiment of the present invention.

In the following detailed description, to simplify the description, like elements are provided like reference numerals.

### DETAILED DESCRIPTION

Software that allows a hardware emulator, emulating a circuit (“emulated device”) to connect to a computer peripheral hardware device is described. In the following description, numerous specific details are set forth, such as the peripheral interface, the operating system, the type of computer, etc., in order to provide a thorough understanding of the present invention. It will be obvious, however, to one skilled in the art that these specific details need not be used to practice the present invention. In other instances, well known structures, functions, and software programs have not been shown in detail in order not to unnecessarily obscure the present invention.

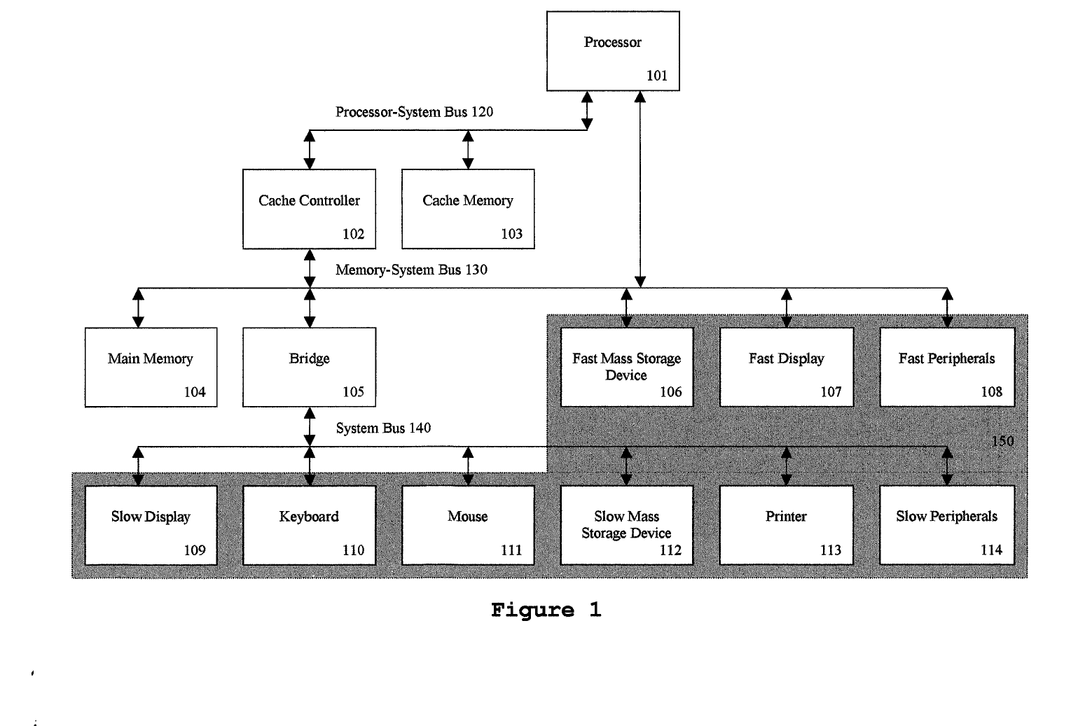

FIG. 1 shows a typical computer configuration that implements the present invention. The processor 101 connects via high-speed processor-system bus 120 to the cache controller 102 and the cache memory 103. Said cache controller 102 connects via a medium speed memory-system bus 130 to main memory 104 and bridge 105 as well as to high speed peripheral devices such as fast mass storage device 106, fast display 107, and other fast peripherals 108. Note that said processor 101 also connects directly via medium speed memory-system bus 130 to said high speed peripherals fast mass storage device 106, fast display 107, and other fast peripherals 108. Said bridge 105 acts to connect the medium speed memory-system bus 130 to low-speed system bus 140 which connects to slow peripherals slow display 109, keyboard 110, mouse 111, slow mass storage device 112, printer 113, and slow peripherals 114. All peripherals, fast or slow, are shown in shaded box 150. Note that peripherals may in fact be boards or chips that drive peripheral devices, but for the purposes of this invention, we do not differentiate between the chips or board that drives a peripheral and the peripheral itself.

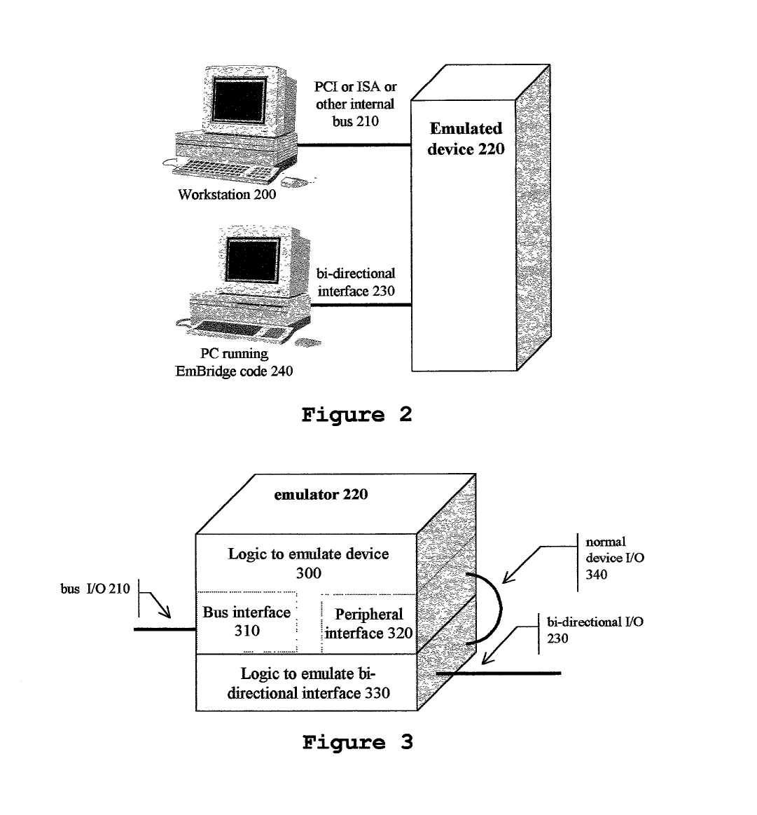

An embodiment of the present invention is illustrated in FIG. 2 using an emulation of a device (“emulated device”). FIG. 2 shows a configuration including workstation 200, host computer 240, and emulator 220. In this embodiment, a device that interfaces with a peripheral is emulated in emulator 220, which interfaces with first workstation 200 over a conventional internal bus 210 (e.g., a PCI bus). The emulated device is intended to operate as a peripheral interface of a workstation, such as workstation 200. However, emulator 220 does not operate at the full speed of the peripheral. Emulator 220 is connected to host computer 240 over bidirectional interface 230, such as a conventional personal computer (PC) parallel port. Host computer 240 runs an interface program “Emridge” which is discussed in further detail below in conjunction with FIG. 3. The peripheral device to which the emulated device connects is a part of host computer 240 or is connected to host computer 240. Host computer 240 can be, for example, a desktop PC running Windows 95 or Windows 98 and equipped with a 10baseT Ethernet controller card and two parallel ports. A proprietary parallel port interface can be used for faster transfer speeds or easier connection to emulator 220. In one embodiment, host computer 240 includes an Intel Pentium class processor and is equipped with 32 Mbytes of DRAM and 500 Mbytes of hard disk space. Host computer 240 also includes the peripheral hardware with which the emulated device interfaces. The peripheral device can be an external peripheral such as a printer or an external modem, or it can be an internal peripheral such as a graphics card or a built-in modem. The software of host computer 240 includes software drivers for both the peripheral device and for the bidirectional port and operating system APIs for both the peripheral device and for the bidirectional port. The bidirectional port drivers and APIs allow the operating system to interact with the parallel port hardware. The peripheral device drivers and APIs allow the host computer to interact with the peripheral device. Host computer 240 also includes a Graphical Users Interface (“GUI”) and a data capture, buffering, and transmission application program, which will be described in further detail later. Workstation 200 can be any conventional workstation, including a PC running the Windows 98 operating system.

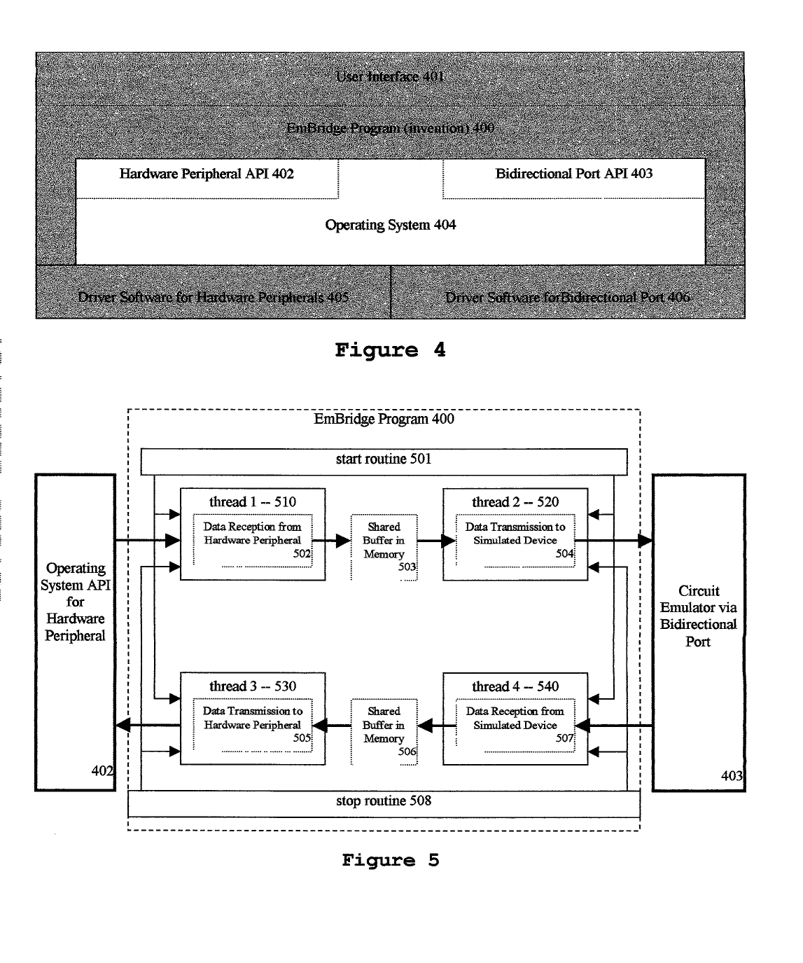

FIG. 4 shows a block diagram of the software executing on processor 101. At the lowest level is the driver software 405 for the computer peripheral. This software, usually supplied by the manufacturer of said peripheral allows computer operating system software 404 to access said peripheral without detailed knowledge of the hardware design or the operation of said peripheral. Said operating system also includes routines called computer peripheral application program interfaces (APIs) 402 that allow application programs to indirectly access said computer peripheral via said operating system. In this way, application programs can control the peripherals but the operating system can override said control or can allocate these peripherals to application programs according to particular priorities.

At the lowest level is also the driver software for the bidirectional port 406. This software, usually supplied by the manufacturer of said bidirectional port allows computer operating system software 404 to access said bidirectional port without detailed knowledge of the hardware design or the operation of said bidirectional port. Said operating system also includes routines called bidirectional port application program interfaces (APIs) 403 that allow application programs to indirectly access the computer peripherals via said operating system. In this way, application programs can control the peripherals but the operating system can override said control or can allocate these peripherals to application programs according to particular priorities.

According to the invention, the EmBridge program 400 is an application program that runs on top of the operating system, which controls the computer resources allocated to it. The EmBridge program 400 can communicate to the emulator 203 via said parallel port API.

Note that the EmBridge program 400 can use the computer peripheral API 402 to access the computer peripherals indirectly. In some cases, to increase performance for example, it may be necessary for the EmBridge program 400 to access the peripheral driver software 405 directly, bypassing the operating system 404 and the APIs provided by the operating system. Similarly, the EmBridge program 400 can use the bidirectional port API 403 to access the bidirectional port indirectly. In some cases, to increase performance for example, it may be necessary for the EmBridge program 400 to access the bidirectional port driver software 406 directly, bypassing the operating system 404 and the APIs provided by the operating system.

The user interface 401 is the part of the EmBridge program 400 that allows the human user to enter information and control operation of the program 400. Said user interface 401 also gives results back to the human user.

In prior art, a custom built, slowed-down computer peripheral device would be connected to the emulator. The emulator would receive data from the slowed-down peripheral and would transmit data to the slowed-down peripheral at the speed of the emulator. Such a slowed-down peripheral is expensive because it requires a custom design. Also, it does not completely predict the behavior of a normal peripheral, operating at full speed, accurately and correctly. Because the peripheral is normally designed to operate at a faster speed, timing issues may arise such that it cannot be slowed down at all.

The present invention overcomes the limitations of the prior art by interfacing a real computer peripheral to the emulated device, taking advantage of standard software that is easily available and has already been fully tested. This standard software includes driver software and APIs that are written by the computer peripheral manufacturer and are included in many standard operating systems. As shown in FIG. 5, data from the emulated device that is intended to drive said computer peripheral is sent to the present EmBridge program 400 from the emulator via the bidirectional port using either the bidirectional port API 403 of the operating system or the bidirectional port driver software 406. EmBridge program 400 sends said data to the computer peripheral either via the computer peripheral API 402 of the operating system or directly to the computer peripheral device driver 405. Data from the computer peripheral is retrieved by the EmBridge program 400 either from the computer peripheral API 402 of the operating system or directly from the computer peripheral device driver 405. The EmBridge program 400 sends said data to the emulator via the bidirectional port using either the bidirectional port API 403 of the operating system or the bidirectional port driver software 406.

FIG. 5 shows an internal block diagram of the EmBridge program. In this embodiment, the EmBridge program 400 has a start routine 501 that initiates the program and begins execution upon input from the user. Said start routine initializes four independent threads that run simultaneously, thread 1 (510), thread 2 (520), thread 3 (530), and thread 4 (540). Thread 1 consists of a data reception routine 502 that receives data from the peripheral either via the operating system API 402 or directly from the peripheral driver. Said data reception routine 502 may obtain said data by polling said peripheral or alternatively via an interrupt mechanism that signals the thread whenever data is available from said peripheral. Said data reception software routine 502 receives said data and stores it in a shared memory buffer 503. Thread 2 consists of data transmission routine 504 that polls said shared buffer 503. When data is available in said shared buffer 503, said data transmission routine 504 retrieves said data. If necessary, data transmission routine 504 modifies said data to be acceptable to said emulator. Data transmission routine 504 then transmits said data to said emulator via the bidirectional port using either the bidirectional port API 403 of the operating system or the bidirectional port driver software.

Thread 4 consists of a data reception routine 507 that retrieves data from the emulator via the bidirectional port using either the bidirectional port API 403 of the operating system or the bidirectional port driver software. Thread 4 may obtain said data by polling said emulator or alternatively via an interrupt mechanism that signals the thread whenever data is available from said emulator. Said data reception routine 507 stores said received data in shared memory buffer 506. Thread 3 consists of data transmission routine 505 that polls said shared buffer 506. When data is available in said shared buffer 306, said data reception routine 505 retrieves said data. If necessary, said data reception routine 505 modifies said data to be acceptable to said peripheral. Said data reception routine 505 then transmits said data to said computer peripheral either via the operating system API 402 or directly to the hardware drivers.

In this embodiment, the EmBridge program 400 has a stop routine 508 that takes input from the user in order to stop all executing threads of the program.

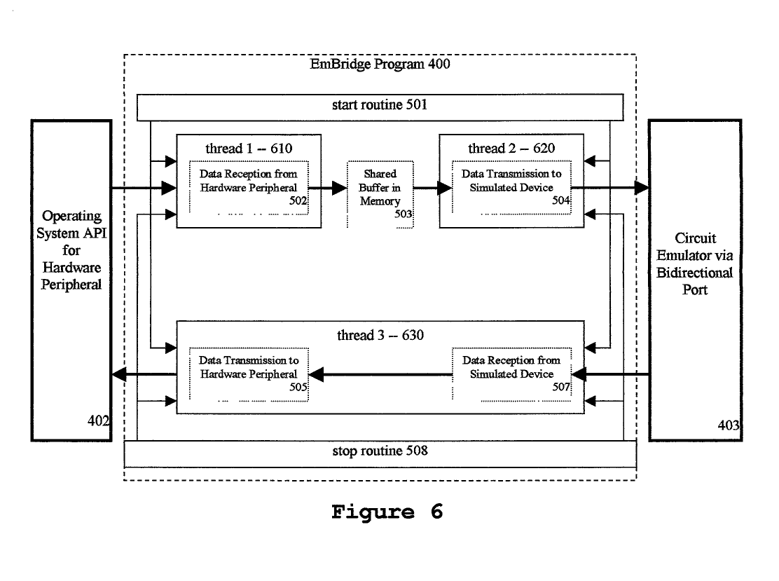

FIG. 6 shows another embodiment of the EmBridge program 400. In this embodiment, the EmBridge program 400 has a start routine 501 that initiates the program and begins execution upon input from the user. Said start routine initializes three independent threads that run simultaneously, thread 1 (610), thread 2 (620), and thread 3 (630). Thread 1 consists of a data reception routine 502 that receives data from the computer peripheral either via the operating system API 402 or directly from the hardware drivers. Said data reception routine 502 may obtain said data by polling the peripheral or alternatively via an interrupt mechanism that signals the thread whenever data is available from said peripheral. Said data reception software routine 502 receives said data and stores it in a shared memory buffer 503. Thread 2 consists of data transmission routine 504 that polls said shared buffer 503. When data is available in said shared buffer 503, said data transmission routine 504 retrieves said data. If necessary, data transmission routine 504 modifies said data to be acceptable to the emulator. Data transmission routine 504 then transmits said data to said emulator via the bidirectional port using either the bidirectional port API 403 of the operating system or the bidirectional port driver software.

Thread 4 consists of a data reception routine 507 that retrieves data from the emulator via the bidirectional port using either the bidirectional port API 403 of the operating system or the bidirectional port driver software and a data transmission routine 505 that transmits said data to the peripheral either via the operating system API 402 or directly to the peripheral driver. Thread 3 may obtain said data by polling said emulator or alternatively via an interrupt mechanism that signals the thread whenever data is available from said emulator. Said data reception routine 507 sends said received data to said data reception routine 505 that modifies said data to be acceptable to the peripheral, if necessary, then transmits said data to said computer peripheral either via the operating system API 402 or directly to the peripheral driver. This embodiment takes advantage of the fact that said emulator is running much slower than the EmBridge program 400 and that said peripheral can receive data at a faster rate than said software can send it. Therefore there is only a single thread to retrieve data from said emulator and send it to said peripheral. In this embodiment, the EmBridge program 400 can perform the entire operation of thread 3 without slowing down said emulator or said peripheral. Unlike the embodiment shown in FIG. 5, this embodiment does not need a shared memory buffer between data reception routine 507 and data transmission routine 505.

In this embodiment, the EmBridge program 400 has a stop routine 508 that takes input from the user in order to stop all executing threads of the program.

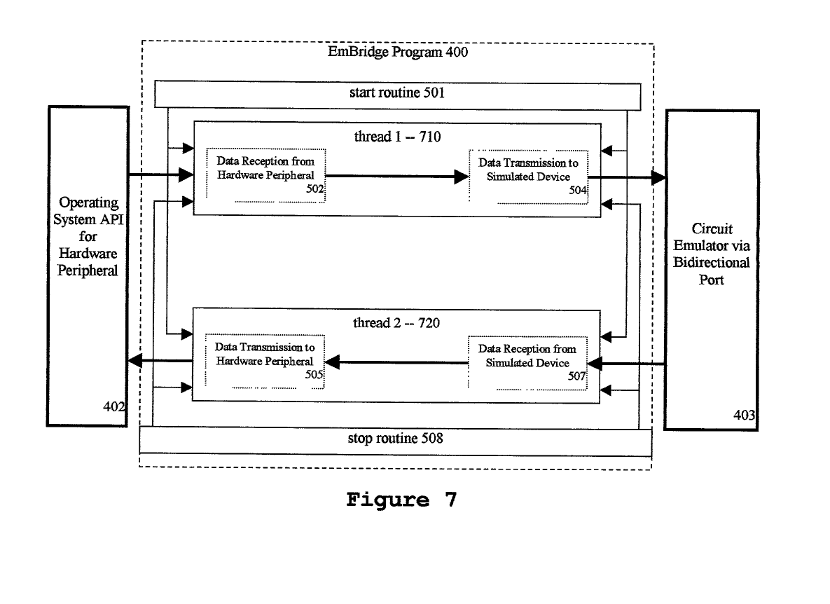

FIG. 7 shows another embodiment of the EmBridge program 400. In this embodiment, the EmBridge program 400 has a start routine 501 that initiates the program and begins execution upon input from the user. Said start routine initializes two independent threads that run simultaneously, thread 1 (710), and thread 2 (720). Thread 1 consists of a data reception routine 502 and a data transmission routine 504. Data reception routine 502 receives data from the peripheral either via the operating system API 402 or directly from the hardware driver. Said data reception routine 502 may obtain said data by polling the peripheral or alternatively via an interrupt mechanism that signals the thread whenever data is available from the peripheral. Data transmission routine 504 then transmits said data to said emulator via the bidirectional port using either the bidirectional port API 403 of the operating system or the bidirectional port driver software. This embodiment takes advantage of the fact that the peripheral sends data at a slower rate than the EmBridge program 400 can receive it. Therefore, there is only a single thread to retrieve data from said peripheral and send it to said emulator. In this embodiment, the EmBridge program 400 can perform the entire operation of thread 1 without missing data from the peripheral. Unlike the embodiment shown in FIG. 6, this embodiment does not need a shared memory buffer between data reception routine 502 and data transmission routine 504.

Thread 2 consists of a data reception routine 507 that retrieves data from the emulator via the bidirectional port using either the bidirectional port API 403 of the operating system or the bidirectional port driver software and a data transmission routine 505 that transmits said data to the peripheral either via the operating system API 402 or directly to the peripheral driver. Thread 2 may obtain said data by polling said emulator or alternatively via an interrupt mechanism that signals the thread whenever data is available from said emulator. Said data reception routine 507 sends said received data to said data reception routine 505 that modifies said data in order to be acceptable to the peripheral, if necessary, then transmits said data to said computer peripheral either via the operating system API 402 or directly to the hardware drivers.

In this embodiment, the EmBridge program 400 has a stop routine 508 that takes input from the user in order to stop all executing threads of the program.

Various modifications and adaptations of the operations described here would be apparent to those skilled in the art based on the above disclosure. Many variations and modifications within the scope of the present invention are therefore possible. The present invention is set forth by the following claims.

I claim:

1) A method for connecting an emulation of an electronic device to a computer peripheral device attached to a computer, said computer peripheral device operating at a higher speed than said emulation, the method comprising:
a) receiving data from said computer peripheral using standard software running on said computer;
b) transmitting said data received from said computer peripheral to said emulation through a bidirectional port using standard software running on said computer;
c) receiving data from said emulation through a bidirectional port using standard software running on said computer; and
d) transmitting said received data from said emulation to said computer peripheral using standard software running on said computer.

2) The method of claim 1) further comprising storing said received data from said computer peripheral in a first buffer in memory.

3) The method of claim 2), further comprising changing the size of said first buffer at run time.

4) The method of claim 1) further comprising storing said received data from said emulation in a second buffer in memory.

5) The method of claim 4), further comprising changing the size of said second buffer at run time.

6) The method of claim 1), further comprising keeping a record of said data received from said computer peripheral, said data transmitted to said emulation, said data received from said emulation, and said data transmitted to said computer peripheral.

7) The method of claim 1), further comprising recording the throughput of said data.

8) The method of claim 1) further comprising modifying said received data from said computer peripheral to make said data suitable for transmission to said emulation.

9) The method of claim 1) further comprising modifying said received data from said emulation to make said data suitable for transmission to said computer peripheral.

10) The method of claim 1), wherein said receiving data from said computer peripheral is executed in a first thread, said transmitting said data received from said computer peripheral is executed in a second thread, said receiving data from said emulation is executed in a third thread, and said transmitting said data received from said emulation is executed in a fourth thread.

11) The method of claim 1), wherein said receiving data from said computer peripheral is executed in a first thread, said transmitting said data received from said computer peripheral is executed in a second thread, said receiving data from said emulation and said transmitting said data received from said emulation are executed in a third thread.

12) The method of claim 1), wherein said receiving data from said computer peripheral and said transmitting the data received from said computer peripheral are executed in a first thread and said receiving data from said emulation and said transmitting the data received from said emulation are executed in a second thread.

13) A method for connecting an emulation of an electronic device to a computer peripheral device attached to a computer, said computer peripheral device running at a higher speed than said emulation, the method comprising:
a) receiving data from said computer peripheral using standard software running on said computer;
b) storing said data received from said computer peripheral in a first buffer;
c) retrieving said data stored in said first buffer;
d) modifying said retrieved data to make said data suitable for transmission to said emulation;
e) transmitting said data received from said computer peripheral to said emulation through a bidirectional port using standard software running on said computer;
f) receiving data from said emulation through a bidirectional port using standard software running on said computer;
g) storing said data received from said emulation in a second buffer;
h) retrieving said data stored in said second buffer;
i) modifying said retrieved data to make said data suitable for transmission to said computer peripheral; and
j) transmitting said received data from said emulation to said computer peripheral using standard software running on said computer.

14) An apparatus for connecting an emulation of an electronic device to a computer peripheral device attached to a computer, said computer peripheral device running at a higher speed than said emulation, the apparatus comprising:
a) a computer having
i) a memory;
ii) a bidirectional port; and
iii) a computer peripheral.
b) computer instructions executable by the computer for:
i) receiving data from said computer peripheral;
ii) transmitting said data received from said computer peripheral to said emulation through said bidirectional port;
iii) receiving data from said emulation through said bidirectional port; and
iv) transmitting said data received from said emulation to said computer peripheral.

15) The apparatus of claim 14) further comprising:
a) a buffer in said memory; and
b) computer instructions executable by the computer for storing data received from said computer peripheral in said buffer.

16) The apparatus of claim 15), further comprising computer instructions executable by the computer for changing the size of said first buffer at run time.

17) The apparatus of claim 14) further comprising:
a) a buffer in said memory; and
b) computer instructions executable by the computer for storing data received from said emulation in said buffer.

18) The apparatus of claim 17), further comprising computer instructions executable by the computer for changing the size of said second buffer at run time.

19) The apparatus of claim 14) further comprising computer instructions executable by the computer for modifying said received data from said emulation to make said data suitable for transmission to said computer peripheral.

20) The apparatus of claim 14) further comprising computer instructions executable by the computer for modifying said received data from said computer peripheral to make said data suitable for transmission to said emulation.

21) The apparatus of claim 14) further comprising computer instructions executable by the computer for keeping a record of said data received from said computer peripheral, said data transmitted to said emulation, said data received from said emulation, and said data transmitted to said computer peripheral.

22) The apparatus of claim 14) further comprising computer instructions executable by the computer for recording the throughput of said data.

23) An apparatus for connecting an emulation of an electronic device to a computer peripheral device attached to a computer, said computer peripheral device running at a higher speed than said emulation, the apparatus comprising:
a) a computer having
i) a memory;
ii) a bidirectional port; and
iii) a computer peripheral.
b) computer instructions executable by the computer for:
i) receiving data from said computer peripheral using standard software running on said computer;
ii) storing said data received from said computer peripheral in a first buffer in memory;
iii) retrieving said data stored in said first buffer;
iv) modifying said retrieved data to make said data suitable for transmission to said emulation;
v) transmitting said data received from said computer peripheral to said emulation through said bidirectional port using standard software running on said computer;
vi) receiving data from said emulation using standard software running on said computer;
vii) storing said data received from said emulation in a second buffer in memory;
viii) retrieving said data stored in said second buffer;
ix) modifying said retrieved data to make said data suitable for transmission to said computer peripheral; and
x) transmitting said received data from said emulation to said computer peripheral using standard software running on said computer.

24) A computer readable medium having computer instructions for connecting an emulation of an electronic device to a computer peripheral device attached to a computer, said computer peripheral device running at a higher speed than said emulation, to perform in a computer:
a) receiving data from said computer peripheral using standard software running on said computer;
b) transmitting said data received from said computer peripheral to said emulation using standard software running on said computer;
c) receiving data from said emulation using standard software running on said computer; and
d) transmitting said data received from said emulation to said computer peripheral using standard software running on said computer.

25) The computer readable medium of claim 24) further comprising computer instructions for storing data received from said computer peripheral in a first buffer.

26) The computer readable medium of claim 25) further comprising computer instructions for changing the size of said first buffer at run time.

27) The computer readable medium of claim 24) further comprising computer instructions for storing data received from said emulation in a second buffer.

28) The computer readable medium of claim 27) further comprising computer instructions for changing the size of said second buffer at run time.

29) The computer readable medium of claim 24) further comprising computer instructions for modifying said received data from said emulation to make said data suitable for transmission to said computer peripheral.

30) The computer readable medium of claim 24) further comprising computer instructions for modifying said received data from said computer peripheral to make said data suitable for transmission to said emulation.

31) The computer readable medium of claim 24) further comprising computer instructions for keeping a record of said data received from said computer peripheral, said data transmitted to said emulation, said data received from said emulation, and said data transmitted to said computer peripheral.

32) The computer readable medium of claim 24) further comprising computer instructions for recording the throughput of said data.

33) A computer readable medium having computer instructions for connecting an emulation of an electronic device to a computer peripheral device attached to a computer, said computer peripheral device running at a higher speed than said emulation, to perform in a computer:
a) receiving data from said computer peripheral using standard software running on said computer;
b) storing said data received from said computer peripheral in a first buffer in memory;
c) retrieving said data stored in said first buffer;
d) modifying said retrieved data to make said data suitable for transmission to said emulation;
e) transmitting said data received from said computer peripheral to said emulation through a bidirectional port using standard software;
f) receiving data from said emulation through a bidirectional port using standard software;
g) storing said data received from said emulation in a second buffer in memory;
h) retrieving said data stored in said second buffer;
i) modifying said retrieved data to make said data suitable for transmission to said computer peripheral; and
j) transmitting said received data from said emulation to said computer peripheral through standard software running on said computer.
